(19) United States
(12) Patent Application Publication
(10) Pub. No.: US 2025/0333652 A1
(43) Pub. Date: Oct. 30, 2025

(54) METHOD AND APPARATUS FOR THE DECOMPOSITION AND PROCESSING OF END OF LIFE AND CONTAMINATED WASTE PLASTICS

(71) Applicant: PLASTRON SOLUTIONS PTY LTD, GOLD COAST, QUEENSLAND (AU)

(72) Inventor: Todd TULK, GOLD COAST, QUEENSLAND (AU)

(21) Appl. No.: 18/708,886

(22) PCT Filed: Nov. 21, 2022
(86) PCT No.: PCT/AU2022/051390

§ 371 Date: May 9, 2024

(30) Foreign Application Priority Data
Nov. 22, 2021 (AU) 2021903759

(51) Int. Cl. C10G 1/02; C10G 9/00

(52) U.S. Cl. CPC C10G 1/02; C10G 9/00; C10G 2300/1003; C10G 2400/02; C10G 2400/04

(57) ABSTRACT

The invention provides a process and apparatus for processing plastic waste by pyrolysis to cause thermochemical breakdown of the plastic waste and producing a hydrocarbon fuel. In particular, the hydrocarbon fuel produced is a ‘near diesel’ pyrolysis oil which can be upgraded or refined to standard fuels or blended with other crude/fuel oil products.

### CROSS REFERENCE TO RELATED APPLICATIONS

This application is a National Stage Application of International Application Number PCT/AU2022/051390, filed Nov. 21, 2022; which claims priority to Australia Patent Application No. 2021903759, filed Nov. 22, 2021; both of which are incorporated herein by reference in their entirety.

### FIELD OF THE INVENTION

The present invention relates to a process and apparatus for processing plastic waste by pyrolysis to cause thermochemical breakdown of the plastic waste and producing a hydrocarbon fuel. In particular, the hydrocarbon fuel produced is a ‘near diesel’ pyrolysis oil which can be upgraded or refined to standard fuels or blended with other crude/fuel oil products. However, it will be appreciated that the invention is not limited to this particular field of use.

### BACKGROUND OF THE INVENTION

The following discussion of the prior art is provided to place the invention in an appropriate technical context and enable the advantages of it to be more fully understood. It should be appreciated, however, that any discussion of the prior art throughout the specification should not be considered as an express or implied admission that such prior art is widely known or forms part of the common general knowledge in the field.

Plastic waste has become a global crisis, with millions of tonnes each year polluting virtually every habitat on our planet, including our own cities, causing significant harm to the land, the oceans and inhabitants. As of 2017-2018, there is more than 160,000 tonnes of plastic waste produced in Australia from municipal sources alone each year that is destined for landfill. Typically, municipal plastic waste/end-of-life plastic waste is either too degraded or too contaminated to be recycled conventionally, and traditional chemical recycling has generally been prohibitively expensive to be considered feasible (low economic return).

Given the recent ban on the import of plastic waste in China and other countries, the amount of condemned plastic is only set to grow. Rather than allowing plastic waste to damage the environment or end up in landfill, there is potential to chemically recycle plastic waste through pyrolysis into fuel grade or near fuel grade hydrocarbons. This can potentially reduce the volume of plastic going to waste while also providing an in-demand product in the form of fuel such as diesel or petrol.

Pyrolysis (or thermolysis) is a process where plastic material is converted into liquid hydrocarbons by thermal cracking at a temperature of typically between 400 and 480° C. in the absence of oxygen or air, in a batch reactor. This process typically involves reducing the long-chain hydrocarbon polymers to smaller hydrocarbon chain lengths.

Diesel fuel is a blend of hydrocarbon compounds known as distillates that are heavier than gasoline but lighter than lubricating oil. Diesel is a mixture of straight-chain and branched alkanes, cyclic saturated hydrocarbons and aromatics. Diesel fuel is designed to operate in a diesel engine only, where it is injected into the diesel engine combustion chamber with compressed, high-temperature air and ignites spontaneously.

In contrast, gasoline in a petrol engine is ignited by a spark such as by spark plugs. Diesel fuel produced by pyrolysis and other methods must meet a range of composition requirements before being certified for sale in a number of countries.

WO 2005/087897 (WO 897) discloses a process for the thermocatalytic conversion of waste materials into reusable fuels, comprising the steps of: delivering waste material to a melting means; directing melted waste material from one or more manifolds into one or more pyrolysis chambers: heating waste material to effect pyrolysis of material into a gaseous state in a substantially oxygen purged and pressure controlled environment; transferring resulting gases to a catalytic converter means wherein the molecular structure of the gaseous material is altered in structure and form; transferring gases to one or more condenser means to distil and cool gases in to their respective fractions; and wherein the fractions form at least one type of useable fuel. WO 897 requires use of a catalyst in the form of a catalytic converter to form at least one type of useable fuel.

WO2017/220504 (WO 504) discloses a process for thermal cracking of a feedstock of plastic materials comprising the steps of melting the feedstock, conveying melted feedstock in a pyrolysis chamber, where said melted feedstock is heated in a substantially oxygen purged environment to convert it into pyrolysis gases, said process further comprising the steps of: driving pyrolysis gases from the pyrolysis chamber into a tray reflux column comprising a partial condenser at its upper extremity, returning pyrolysis gases condensed in the tray reflux column into the pyrolysis chamber, distilling pyrolysis gases exiting the partial condenser of the tray reflux column, to provide one or more fuel products. WO 504 discloses that the pyrolysis gases formed are continuously extracted from the pyrolysis chamber so as to maintain a pressure between 250 and 300 millibars (i.e., between −0.25 and 0.30 atm).

Additionally, it is typical that industrial scale plants which process waste plastic material to form hydrocarbon fuel by pyrolysis are fixed plants and require large scale equipment and therefore high upfront capital costs, typically above about $50 million AUD.

It is therefore desirable to develop an improved or alternative process and apparatus to form a hydrocarbon fuel from waste plastic material which can be at least one of improved efficiency, provide mobility of the plant or provide easier maintenance/operation for the end user/operator.

It is an object of the present invention to overcome or ameliorate at least one of the disadvantages of the prior art, or to provide a useful alternative.

Unless the context clearly requires otherwise, throughout the description and the claims, the words “comprise”, “comprising”, and the like are to be construed in an inclusive sense as opposed to an exclusive or exhaustive sense; that is to say, in the sense of “including, but not limited to”.

Although the invention will be described with reference to specific examples it will be appreciated by those skilled in the art that the invention may be embodied in many other forms.

### SUMMARY OF THE INVENTION

Continuous development of pyrolysis systems has driven the desire to develop alternative processes and apparatuses particularly for recycling end-of-life and municipal waste plastic materials. In particular, there is a desire to develop an improved or alternative process and apparatus to form a hydrocarbon fuel from waste plastic material which can be at least one of improved efficiency, provide mobility of the plant or provide easier maintenance/operation for the end user/operator.

The present invention can in some embodiments provide a containerised plant as a ‘one size fits all’ design. As used herein, the term containerised plant refers to a plant which can be assembled using containerised units. Each containerised unit includes a plurality of process stages for the production of hydrocarbon fuel. In contrast, previously disclosed plants use modular units, wherein each modular unit includes a single process stage only. The containerised plant of the present invention therefore consolidates the process stages into containerised units for simplicity in transport and expansion. Examples of suitable containers including standard shipping containers (such as 10 ft, 20 ft, or 40 ft long shipping containers, 8 ft wide and either 8 ft 6 inches or 9 ft 6 inches high). Due to the ease of shipping/freight of a containerised plant, the plants can be manufactured and deployed anywhere in the world that is reachable by water and/or land, such as, rail, roads, canals (and potentially air) and the like, or even on barges or boats for deployment to island nations that have plastic waste problems. The addition of an ancillary generator system can provide electricity to remote/regional communities whilst also removing plastic waste. This can provide an avenue for deployment of the plants as described herein in remote regions affected by industrial pollution, or where there are large incumbent plastic waste streams.

Process for Producing a Hydrocarbon Fuel from a Plastic Material feedstock

According to one aspect, the present invention provides a process for producing a hydrocarbon fuel from a plastic material feedstock, comprising the steps of:
feeding a quantity of a feedstock of a plastic material to a pyrolysis reactor vessel;
heating the feedstock of plastic material in the pyrolysis reactor vessel at a pyrolysis temperature to form pyrolysis gases, wherein the pyrolysis reactor vessel is substantially oxygen free and at about atmospheric pressure;
condensing at least a portion of the pyrolysis gases in a condenser such that the condensed pyrolysis gases are returned to the pyrolysis reactor vessel;
optionally repeating the heating and condensing steps to undergo further pyrolysis; and
collecting at least a first product stream comprising a hydrocarbon fluid formed from pyrolysis to provide a hydrocarbon fuel; and wherein the process does not comprise a catalyst.

Advantageously, the present inventors have developed a process and apparatus as described herein for producing hydrocarbon fuels which are near-diesel without requiring use of a catalyst. The hydrocarbon fuels can be further refined or processed.

As would be appreciated by a skilled addressee, any suitable pyrolysis temperature can be used. As would be understood by a skilled addressee, the pyrolysis temperature is the temperature at which thermal decomposition of the plastic materials occurs to form pyrolysis gases.

In certain embodiments, the pyrolysis temperature is between about 40 to about 900° C. In certain embodiments, the pyrolysis temperature is between about 100 to about 900° C. In certain embodiments, the pyrolysis temperature is between about 200 to about 600° C. In certain embodiments, the pyrolysis temperature is between about 300 to about 600° C. In certain embodiments, the pyrolysis temperature is between about 100 to about 550° C. In certain embodiments, the pyrolysis temperature is between about 200 to about 600° C. In certain embodiments, the pyrolysis temperature is between about 200 to about 500° C. In certain embodiments, the pyrolysis temperature is between about 200 to about 450° C. In certain embodiments, the pyrolysis temperature is between about 40 to about 450° C. In certain embodiments, the pyrolysis temperature is between about 200 to about 300° C. In certain embodiments, the pyrolysis temperature is between about 300 to about 400° C. In certain embodiments, the pyrolysis temperature is between about 200 to about 390° C. In certain embodiments, the pyrolysis temperature is between about 250 to about 350° C. In preferred embodiments, the pyrolysis temperature is preferably between about 200 to about 400° C. In some embodiments, the temperature of the pyrolysis reactor vessel depends on the feedstock material and can also depend on the amount of wax material in the feedstock.

In some embodiments, the reaction melt formed during the heating step is agitated. This can reduce or prevent formation of ‘hot zones’ and to assist/promote mixing within the pyrolysis reactor vessel.

In some embodiments, the plastic material is a single type of plastic. In some embodiments, the plastic material is mixed plastic. In some embodiments, the feedstock of plastic material is washed prior to feeding the quantity of a feedstock of a plastic material to a pyrolysis reactor vessel. In some embodiments, the feedstock of plastic material is not washed prior to feeding the quantity of a feedstock of a plastic material to a pyrolysis reactor vessel.

The pressure of the pyrolysis reactor vessel is near or about atmospheric pressure. Advantageously, use of near or about atmospheric pressure for the pyrolysis reactor vessel can minimise costs as it does not require use of a sophisticated vacuum chamber or equipment and does not require high pressure reactor vessels. In these embodiments, the pyrolysis reactor vessel can be of a portable size to fit into a shipping container for easy transport and modular assembly, or spread across multiple containers.

In some embodiments, the pressure of the pyrolysis reactor vessel is between about 80 to about 120 kPa. In some embodiments, the pressure of the pyrolysis reactor vessel is between about 80 to about 110 kPa. In some embodiments, the pressure of the pyrolysis reactor vessel is between about 80 to about 105 kPa. In some embodiments, the pressure of the pyrolysis reactor vessel is between about 85 to about 105 kPa. In some embodiments, the pressure of the pyrolysis reactor vessel is between about 90 to about 105 kPa. In some embodiments, the pressure of the pyrolysis reactor vessel is between about 80 to about 100 kPa. In some embodiments, the pressure of the pyrolysis reactor vessel is between about 90 to about 100 kPa. In some embodiments, the pressure of the pyrolysis reactor vessel is between about 80 to about 95 kPa. In some embodiments, the pressure of the pyrolysis reactor vessel is between about 85 to about 95 kPa. In some embodiments, the pressure of the pyrolysis reactor vessel is atmospheric pressure (101.3 kPa). The pyrolysis reactor vessel of the present invention is near atmospheric pressure or about atmospheric pressure which can provide ease of economic scaling and mass production.

In some embodiments, toxic off gases and pollutants produced by the process of the invention are minimised. In some embodiments, the process further comprises a scrubber adapted to capture the toxic off gases and pollutants produced by the process of the invention.

The present invention as described herein can be performed using a pyrolysis reactor vessel which is substantially oxygen free. In certain embodiments, the pyrolysis reactor vessel is oxygen free. In some embodiments, the oxygen content of the pyrolysis reactor vessel is less than about 20%. In some embodiments, the oxygen content of the pyrolysis reactor vessel is less than about 15%. In some embodiments, the oxygen content of the pyrolysis reactor vessel is less than about 10%. In some embodiments, the oxygen content of the pyrolysis reactor vessel is less than about 8%. In some embodiments, the oxygen content of the pyrolysis reactor vessel is less than about 5%, less than about 4%, less than about 3%, less than about 2%, less than about 1%, less than about 0.5%, less than about 0.3%, less than about 0.1%. In some embodiments, an inert atmosphere is used in the pyrolysis reactor vessel. In some embodiments, the inert atmosphere is comprised of nitrogen, argon, carbon monoxide, carbon dioxide, helium, neon, krypton, xenon, radon and/or mixtures thereof.

As used herein, oxygen content is a relative measure of the concentration of oxygen that is carried in a given medium as a proportion of the maximal concentration that can be dissolved in that medium. The unit of oxygen content is percent (%), by weight.

As would be appreciated by a skilled addressee, the substantially oxygen free or oxygen free pyrolysis reactor vessel can be provided using any suitable approach for example by purging the surrounding environment using an inert gas such as nitrogen. In preferred embodiments, the pyrolysis reactor vessel is substantially purged by flue gas produced by the burner system which provides the substantially oxygen free environment. However, any other suitable means of reducing the oxygen content of the pyrolysis reactor vessel can be used.

In some embodiments, the substantially oxygen free or oxygen free pyrolysis reactor vessel is maintained by means of a substantially gas-tight vessel and an initial introduced quantity of inert gas. In some alternative embodiments, the inert gas atmosphere is maintained by means of a positive flow of inert gas being fed into the vessel. For example, inert gas such as argon, nitrogen, carbon dioxide, carbon monoxide, helium, neon, argon, krypton, xenon, radon and combinations thereof can be periodically pumped into the vessel via a gas entry port, to displace any oxygen which may find its way in. In certain embodiments, the inert gas is selected from the group consisting of argon, nitrogen and combinations thereof.

The pyrolysis reactor vessel may have an oxygen or an inert gas sensor for monitoring the level of inert gas (such as argon, nitrogen and the like) which is used to fill voids in the vessel and/or detecting oxygen within the vessel.

Methods of testing the condition of the inert gas may include: i) when temperature is stable, by conducting a pressure hold test; ii) using an oxygen sensor to detect presence of oxygen within the vessel; iii) measuring flow of inert gas into the panel to detect abnormal inflow rates.

Sensors for measuring a condition of an inert gas such as argon and/or pressure in the pyrolysis reactor vessel may also be connected to a programmable logic controller (PLC) and the PLC may be programmed to monitor the sensors and to control the pressure reducing valves, pressure regulator valves, pumps or other ancillary devices to regular the flow or inert gas or cut the supply of power/energy the pyrolysis reactor vessel if the condition of the inert gas in it deteriorates below a predetermined level, if the oxygen content is above a predetermined level or if the pressure of the vessel is unstable, such as by pressure dropping below a predetermined level or pressure or decreasing rapidly. The pyrolysis reactor vessel may also have a pressure relief valve to vent excess gas if the pressure exceeds a predetermined level. In some embodiments, the predetermined level is substantially above atmospheric pressure.

In preferred embodiments, the substantially oxygen free and about atmospheric pressure environment of the pyrolysis reactor vessel is provided by flue gas, preferably from the burner system of the apparatus of the present invention. As would be appreciated by a skilled addressee, the composition of the flue gas depends on a number of factors including the composition of the plastic material feedstock. Typically, flue gas comprises mostly nitrogen (typically more than 70%) derived from the combustion in air, carbon dioxide (OO₂), and water vapor as well as excess unreacted oxygen (also derived from the combustion air).

In some embodiments, the process comprises repeating the heating and condensing steps of pyrolysis gases at least once, twice, three, four, five, six, seven, eight, nine, or ten times. In some embodiments, the process comprises repeating the heating and condensing steps of pyrolysis gases once, twice, three, four, five, six, seven, eight, nine, or ten times.

In some embodiments, the process comprises producing a hydrocarbon fuel using a plurality of apparatus as described herein in series or parallel to increase output. In some embodiments, the process comprises two, three, four, five, six, seven, eight, nine or ten apparatus. In some embodiments, process comprises at least two, at least three, at least four, at least five, at least six, at least seven, at least eight, at least nine or at least ten apparatus.

In some embodiments, the process of the present invention provides a first product stream or pyrolysis gases having an average hydrocarbon chain length of less than 25 carbon atoms, less than 22 carbon atoms, less than 20 carbon atoms, less than 18 carbon atoms, less than 16 carbon atoms, less than 15 carbon atoms.

In some embodiments, the process of the invention is self-cleaning. In these embodiments, each component of the process can be provided for example with at least one nozzle to spray the surfaces of the components to clean the parts during off times when the plant is not processing plastic material.

In some embodiments, the plastic material is fed into the reactor without any assistance, for example, the process is self fed or gravity fed. In these embodiments, the process can comprise a storage vessel or hopper and the like such that the feedstock of plastic material can be continuously topped up as plastic waste is transported to the plant.

In some embodiments, the process of the present invention further comprises at least one flash distillation step prior to the collection step. In these embodiments, the flash distillation step can be performed using a flash tank. In some embodiments, the process of the present invention further comprises at least two flash distillation steps prior to the collection step. In these embodiments, the pyrolysis oil formed by condensing at least a portion of the pyrolysis gases in the pyrolysis reactor vessel flow into a first effect flash tank, where the separation of ‘non-condensables’ from the pyrolysis oil occurs. The more volatile hydrocarbons are flashed off, with any of the heavy hydrocarbon products coalescing on a mist eliminator of the tank. The liquid product can then flow to a fractionator buffer tank. The vapour product can optionally enter a second effect flash tank. The second effect flash tank is similar to the first effect flash tank which can provide greater separation between the light and heavy hydrocarbon products.

The process of the present invention provides a first product stream comprising a hydrocarbon fluid formed from pyrolysis to provide a hydrocarbon fuel. In certain embodiments, the first product stream is selected from the groups consisting of a liquid, gas, solid and combinations thereof. In some embodiments, the first product stream is a liquid, preferably a pyrolysis oil. In certain embodiments, the first product stream is substantially a diesel fuel (near diesel), kerosene or petrol. The first product stream is typically a near finished market ready fuel. In some embodiments, the first product stream meets at least two specifications of ASTM standards selected from the group consisting of ASTM D9752, ASTM D3699 (Petrol D4814), ASTM D4814 (Kerosene D3699) and combinations thereof. In some embodiments, the first product stream meets at least three, four, five or six specifications of ASTM standards selected from the group consisting of ASTM D9752, ASTM D3699 (Petrol D4814), ASTM D4814 (Kerosene D3699) and combinations thereof.

In some embodiments, the first product stream comprises a further refinement step. Advantageously, this can provide a higher grade of fuel and/or provide diesel or petrol fuel by refinement using methods known to those skilled in the art. In certain embodiments, the first product stream can be blended with crude or refined hydrocarbon fuels or existing fuel blends to provide different product specifications under ASTM standards.

In some embodiments, the process of the present invention provides a second product stream of hydrocarbon fuel. In certain embodiments, the second product stream is a liquid, gas and combinations thereof. In preferred embodiments, the second product stream is a hydrocarbon gas. In preferred embodiments, the second product stream is scrubbed to provide a scrubbed vapour. In certain embodiments, the scrubbed vapour is a fuel source. In certain embodiments, the process further comprises feeding the second product stream to a burner system.

In certain embodiments, the process of the present invention provides a third product stream. In some embodiments, the third product stream is a solid, preferably a char. In certain embodiments, the process further comprises feeding the third product stream to a burner system. Advantageously, feeding the char from the reactor to the burner system can reduce solids by-products from the pyrolysis reactor vessel. Feeding of the second product stream and/or third product stream to the burner system can advantageously allow the apparatus to substantially self-perpetuate based on the second product stream and/or third product stream to produce hydrocarbon fuel. This embodiment can also dry the feedstock of plastic material (such as plastic flakes pre hopper) and preheats the plastic flakes in the feed inlet (i.e., heated screw feeder) prior to entry to the pyrolysis reactor vessel which can also in turn partially heat the pyrolysis reactor vessel via flue gases. In these embodiments, once the process and apparatus are at operating temperature, the process and apparatus of the present invention can operate off its own non condensable gases and char.

As would be appreciated by a skilled addressee, the yield of the first, second and/or third product streams can be dependent on a number of factors including the source, contamination and the type of plastic of the plastic material feedstock. In some embodiments, the yield of the first product stream is between about 50 to about 85 w/w %. In some embodiments, the yield of the first product stream is between about 55 to about 85 w/w %. In some embodiments, the yield of the first product stream is between about 50 to about 80w/w %. In some embodiments, the yield of the first product stream is between about 55 to about 80 w/w %. In some embodiments, the yield of the first product stream is between about 57 to about 80 w/w %. In some embodiments, the yield of the first product stream is between about 57 to about 77 w/w %.

In some embodiments, the yield of the second product stream is between about 2to about 40 w/w %. In some embodiments, the yield of the second product stream is between about 2 to about 35 w/w %. In some embodiments, the yield of the second product stream is between about 5 to about 40 w/w %. In some embodiments, the yield of the second product stream is between about 7 to about 40 w/w %. In some embodiments, the yield of the second product stream is between about 7 to about 35 w/w %. In some embodiments, the yield of the second product stream is between about 7 to about 30 w/w %. In some embodiments, the yield of the second product stream is between about 9 to about 30 w/w %. In some embodiments, the yield of the second product stream is between about 9 to about 28 w/w %.

In some embodiments, the yield of the third product stream is less than 30 w/w %. In some embodiments, the yield of the third product stream is less than 25 w/w %. In some embodiments, the yield of the third product stream is less than 20 w/w %. In some embodiments, the yield of the third product stream is less than 15 w/w %. In some embodiments, the yield of the third product stream is less than 10 w/w %.

The total percentage of the yield of the first, second and third product streams is 100 w/w.

Any suitable plastic material can be used in the process of the present invention. For example, the plastic can be clean plastic (washed) or highly contaminated land-based plastics such as municipal waste. Suitable plastic materials can be selected from the group consisting of polyethylene (high density polyethylene, HDPE and low density polyethylene, LDPE), polypropylene (PP), polystyrene (PS), polyvinyl chloride (PVC), polyethylene terephthalate (PET), polymethylenepentene, polycarbonate, polysulfone and combinations thereof. In preferred embodiments, the plastic materials are selected from the group consisting of polyethylene (high density polyethylene, HDPE and low density polyethylene, LDPE), polypropylene, polystyrene, polyvinyl chloride, polyethylene terephthalate and combinations thereof. In more preferred embodiments, the plastic materials are selected from the group consisting of polyethylene (high density polyethylene, HDPE and low density polyethylene, LDPE), polypropylene, polystyrene and combinations thereof. In this embodiment, PVC and PET can be removed prior to providing the feedstock of plastic materials as these materials can release harmful gaseous species during pyrolysis such as chlorine, hydrogen chloride, hydrogen sulfide (such as being released from polysulfone or certain dyes present in a plastic feedstock) or other volatile organic compounds (VOCs).

In some embodiments, toxic off gases and pollutants produced by the process of the invention are minimised. In these embodiments, this can be provided by using a single type of plastic material prior to feeding into the pyrolysis reactor vessel. In some embodiments, this can be provided by removing or sorting plastic materials which can release harmful gaseous species such as plastic materials comprising polysulfone or certain dyes present in a plastic feedstock. Removal of PVC and PET from the feedstock of plastic material can also minimise the amount of toxic off gases and pollutants produced by the process of the present invention. In some embodiments, the process further comprises a scrubber adapted to capture the toxic off gases and pollutants produced by the process of the invention. In these embodiments, a mixture of plastic materials comprising materials which can potentially release harmful off gases can be used with less sorting required prior to feeding into the pyrolysis reactor vessel.

Any suitable size of the feedstock of a plastic material can be used in the process and apparatus of the present invention. In some embodiments, the feedstock of a plastic material is provided in its original form such as a bottle or container. In certain embodiments, the feedstock of a plastic material is non-cleaned (unwashed). In some embodiments, the feedstock of a plastic material is a comminuted plastic material. In certain embodiments, the comminuted plastic material has an average diameter of less than about 50 mm, less than about 40 mm, less than about 30 mm, less than about 25 mm. In certain embodiments, the comminuted plastic material has an average diameter of between about 5 to about 50 mm, between about 5 to about 40 mm, between about 5 to about 30 mm, between about 5 to about 25 mm, between about 10 to about 25 mm, between about 15 to about 25 mm. In preferred embodiments, the comminuted plastic material has an average diameter of between about 15 to about 25 mm.

In certain embodiments, the process of the present invention can comprise a comminution step prior to feeding a quantity of a feedstock of a plastic material to the pyrolysis reactor vessel. In certain embodiments, the process of the present invention can further comprise a classification step to classify (sort by size) the comminuted plastic material. The apparatus can comprise a shredder, grinder or the like to comminute the plastic feed stock and a cyclone or the like can classify the comminuted plastic material.

In certain embodiments, the process of the present invention can further comprise a sorting step using any suitable classifying apparatus known to those skilled in the art. In some embodiments, the sorting step is performed using a near-infrared sorter (NIR). In this embodiment, the comminuted plastic material (plastic flakes) are sorted by ejecting the flakes of a certain wavelength through air pulsation jets/knives. In some embodiments, the sorter can sort a mixture of different plastic material into their own material type such as PET, PVC, polypropylene/polyethylene, polystyrene and others. The sorting or removal of PET can be beneficial due to its monetary value. The sorting or removal of PVC from the process of the present invention can be important due to the hydrogen chloride and chlorine gas which can form during pyrolysis. Advantageously, the high throughput NIR sorter can provide near-pure PET flakes with no constraint on the throughput of plastic feed into the reactor.

In other embodiments, the sorting step can further comprise a magnet to remove ferrous-based metal impurities. As the presence of metals can have adverse effects on the process of the present invention, ferrous metals can be optionally removed before feeding the pyrolysis reactor vessel using a magnet. In these embodiments, the magnet can be selected from the group consisting of a permanent magnet or electromagnet.

In other embodiments, the sorting step can further comprise an X-ray based spectrometer such as X-ray fluorescence or X-ray transmission, an eddy current separator, a wet-mechanical separator (also known as dense media separation), flotation, mechanical separation such as a grill/screen which optionally vibrates; and combinations thereof to remove non-ferrous metals from the plastic feedstock.

As would be appreciated by a skilled addressee, the presence of organic material contamination of the plastic material feedstock can also have adverse effects on the process of the present invention. In certain embodiments, the process can further comprise a washing step prior to feeding the feedstock of plastic material. In certain embodiments, the process can further comprise a washing step and drying step prior to feeding the feedstock of plastic material.

In preferred embodiments, the comminuted plastic material can be preheated to partially or substantially melt the plastic material prior to feeding the feedstock of the plastic material to the pyrolysis reactor vessel. In certain embodiments, the feedstock of the plastic material can be preheated at a temperature between about 150 to about 350° C., between about 100 to about 250° C., between about 150 to about 300° C., between about 200 to about 350° C., between about 200 to about 250° C., between about 200 to about 220° C.

Any suitable condensation temperature can be used in the process of the present invention. The condensation temperature used during the condensation step can provide adjustment or control of the chemical composition of the formed hydrocarbon fluid due to the different boiling point and vapour pressures of the pyrolysis gases or through different residence times of intermediate products within the pyrolysis reaction. In some embodiments, the condensation step is performed at a temperature of between about 40 to about 200° C., between about 70 to about 200° C., between about 70 to about 180° C., between about 40 to about 150° C., between about 70 to about 150° C., or between about 100 to about 150° C.

In some embodiments, the process of the present invention further comprises a generator. In this embodiment, the generator is at least some of the second product within the generator. In certain embodiments, the generator is fed pyrolysis oils and vapours to generate electrical energy. In some embodiments, the second product is a syngas comprising hydrogen. In these embodiments, the hydrogen of the syngas can be separated and fed into a fuel cell. In these embodiments, the generator generates electricity through the combustion of pyrolysis gases and/or oils in a genset. The off gases from the generator can then be fed back via an exhaust to the plant scrubber to provide a circular process to create clean electricity to be fed into the main electrical grid or for charging (such as charging electric vehicles).

In preferred embodiments, the process is a continuous process. In other embodiments, the process is a batch, semi-batch or continuous process. In preferred embodiments, the process is a continuous batch process. In some embodiments, the quantity of a feedstock of a plastic material is between about 500 kg/day to about 6 tonnes/day, between about 500 kg/day to about 5 tonnes/day, between about 750 kg/day to about 5 tonnes/day, between about 1 tonne/day to about 6 tonnes/day or between about 1 tonne/day to about 5 tonnes/day per containerised unit. As would be appreciated by a skilled addressee, the quantity of a feedstock of a plastic material can be increased by using a plurality of containerised units in parallel as described herein in respect of the containerised plant as described herein. In embodiments wherein the process is continuous, the quantity of a feedstock of a plastic material can be reduced to 500 kg or increased up to 6 tonnes per day allowing the apparatus to operate 24 hours per day. The quantity of a feedstock of a plastic material can also be stacked by adding an additional pyrolysis unit (i.e., pyrolysis reactor vessel) which can increase the maximum volume from 6 tonnes per day to 12 tonnes per day. The addition of a third pyrolysis reactor vessel can increase the daily quantity of a feedstock of a plastic material to 18 tonnes per day and so on. The pyrolysis reactor vessels can in some embodiments all be fed by a single pre pyrolysis plastic preparation/processing containerised unit. As already described herein, the apparatus thereby provides feeding of a feedstock of plastic material in one end (input) and hydrocarbon fuel at the other end (output) and once the machine is at operating temperature, the apparatus substantially self-perpetuates.

The competition within the waste-to-fuel market typically focuses on economies of scale with their processing plants operating at above 6 tonnes/day of plastic waste material. Typically, conventional plants are generally very large, fixed and require high capital investment. Advantageously, the use of a quantity of a feedstock of a plastic material less than 6 tonnes/day can address the gap in the market for larger capacity, containerised mobile plants and portability as the equipment can be modularly assembled in single or a plurality of shipping containers such as 20-ft or 40-ft shipping containers. This can in some embodiments provide for easy deployment of the plants and equipment via standard 40-ft trucks. In other embodiments, the plant can be built to be an appropriate size for a particular use case for example to meet different demands. In some circumstances, this may be a small containerised plant and in others it may be a fixed processing plant of any size.

It should be appreciated that each further pyrolysis reactor vessel is independent of each other in the present invention.

Apparatus for Producing a Hydrocarbon Fuel from a Plastic Material Feedstock

According to another aspect, the present invention provides an apparatus for use in the production of hydrocarbon fuel from a plastic material feedstock, the apparatus comprising:
a pyrolysis reactor vessel;
a feed inlet for feeding a plastic material feedstock into the pyrolysis reactor vessel;
a heating element for heating the pyrolysis reactor vessel configured such that a plastic material feedstock in the pyrolysis reactor vessel is heated at a pyrolysis temperature to form pyrolysis gases;
an agitator disposed within the pyrolysis reactor vessel to agitate a reaction melt of the plastic material feedstock in the pyrolysis reactor vessel during operation;
a condenser integrated with the pyrolysis reactor vessel to condense at least a portion of the pyrolysis gases such that the condensed pyrolysis gases are returned to the pyrolysis reactor vessel; and
an outlet for collecting a first product stream comprising a hydrocarbon fluid formed from pyrolysis to provide a hydrocarbon fuel from the pyrolysis reactor vessel;

wherein pyrolysis reactor vessel is substantially oxygen free and at about atmospheric pressure; and wherein the pyrolysis reactor vessel does not comprise a catalyst.

In certain embodiments, the feed inlet is a directional channel to reduce or prevent bypass of gasses in the pyrolysis reactor vessel. In preferred embodiments, the feed inlet is a directional nozzle. In some embodiments, the feed inlet is substantially perpendicular to the direction of flow of a pyrolysis gas stream.

As would be appreciated by a skilled addressee, the rising of pyrolysis gases formed during pyrolysis from the reaction melt is the direction of flow of a pyrolysis gas stream.

In certain embodiments, the outlet is a side draw channel which is substantially perpendicular to the direction of flow of a pyrolysis gas stream. In preferred embodiments, the curved channel or the outlet further comprising a bend is substantially directed towards a parallel axis of the direction of flow of a pyrolysis gas stream.

In certain embodiments, the side draw channel is a conduit, preferably in the form of a tube or pipe. In certain embodiments, the outlet is a curved channel or further comprises a bend. In some embodiments, the bend angle of the outlet is between about 20 to about 100°, between about 40 to about 90°, between about 50 to about 100°, between about 60 to about 100°, between about 70 to about 100°, between about 80 to about 100°, preferably about 90°.

In some embodiments, the condenser is a stack condenser. In preferred embodiments, the condenser is integrated with the pyrolysis reactor vessel. In preferred embodiments, the condenser is integrated within the pyrolysis reactor vessel. In certain embodiments, the condenser is parallel to the direction of flow of a pyrolysis gas stream. In preferred embodiments, the condenser is substantially co-aligned with the direction of flow of a pyrolysis gas stream. In certain embodiments, the condenser comprises a plurality of parallel coolant channels. In certain embodiments, the condenser comprises a plurality of spiral wound coolant channels. In some embodiments, the condenser comprises coolant channels which surrounds at least a portion of the condenser. In some embodiments, the condenser comprises coolant channels which substantially surrounds the condenser. In some embodiments, the condenser further comprises a demister.

Any suitable coolant fluid can be used in the coolant channels of the condenser or pyrolysis oil condenser. In certain embodiments, the coolant fluid is water or an aqueous solution. In certain embodiments, the coolant fluid is selected from the group consisting of water, oil (such as mineral oil, vegetable oil, polyphenyl ether, diphenyl ether, biphenyl, polychlorinated biphenyl, polychlorinated terphenyl), silicone oil, fluorocarbon oil, transformer oil, molten metals and salts thereof and combinations thereof.

In some embodiments, the pyrolysis reactor vessel further comprises an agitator. Any suitable agitator can be used, such as an impeller, high-speed stirrer, mixing rod, mixing paddle, homogenizer, rotator or screw agitator and combinations thereof. In preferred embodiments, the agitator is substantially co-aligned with the direction of flow of a pyrolysis gas stream. In some embodiments, the agitator is used as the injection point for inert gas.

In certain embodiments, the heating element is an electrical resistor, heat exchanger, enclosure or induction heater. In preferred embodiments, the heating element surrounds a portion of the pyrolysis reactor vessel. In some embodiments, the heating element surrounds the pyrolysis reactor vessel.

In some embodiments, the heating element is in the form of an enclosure surrounding a portion of the pyrolysis reactor vessel, preferably, in the form of a heating jacket. In this embodiment, the enclosure can receive flue gas from the burner system which can be the primary heat source of the pyrolysis reactor vessel. In some embodiments, the pyrolysis reactor vessel comprises one, two, three, four, five, six, seven, eight, nine or ten heating elements. In preferred embodiments, the pyrolysis reactor vessel comprises at least one heating element. In preferred embodiments, the pyrolysis reactor vessel comprises one heating element. In this embodiment, the enclosure can recover energy through the process of the present invention and/or further generate electricity. For example, the process of the present invention can operate from heat generated by the combustion of non-condensable gases in char to form high temperature flue gas. Further, the process of the present invention can operate from electricity generated by the combustion of non-condensable gases with the generator as described herein.

In some embodiments, the feed inlet is a screw feeder or conveyer belt, preferably a screw feeder that is heated by flue gas or gases and injected with an inert gas such as but not limited to argon, nitrogen, carbon dioxide, carbon monoxide, helium, neon, krypton, xenon, radon and combinations thereof. In certain embodiments, the screw feeder or conveyor belt is heated by external resistance heating or indirect heating using flue gas to complete pre-heating and melting of plastic material during feeding to the pyrolysis reactor vessel. In certain embodiments, the feed inlet is a screw feeder and/or a pressurised injector nozzle (i.e., feedstock is injected under pressure directly into the pyrolysis reactor vessel operating as outlined in paragraph of this specification). In preferred embodiments, the screw feeder is heated. In preferred embodiments, the feed inlet comprises an inert gas stream to prevent oxygen from entering the pyrolysis reactor vessel.

In certain embodiments, the apparatus further comprises a pyrolysis oil condenser in fluid communication with the outlet of the pyrolysis reactor vessel.

In certain embodiments, the apparatus further comprises at least one flash tank, preferably two flash tanks, wherein the at least one flash tank is in fluid communication with the pyrolysis oil condenser. In some embodiments, the apparatus comprises one, two, three, four or five flash tanks for the flash distillation step.

In preferred embodiments, the apparatus further comprises an intercooler in fluid communication with the at least one flash tank, more preferably wherein the intercooler is in fluid communication between two flash tanks.

In some embodiments, the pyrolysis reactor vessel comprises an outlet to remove a third product stream. In certain embodiments, the outlet to remove a third product stream is a removal screw, preferably a char screw to remove the char formed from pyrolysis of the plastic material feedstock. In some embodiments, the pyrolysis reactor vessel comprises an outlet to remove a third product stream via a screw feeder, preferably heated by flue gas and injected with an inert gas such as but not limited to argon, nitrogen, carbon dioxide, carbon monoxide, helium, neon, krypton, xenon, radon and combinations thereof to remove oxygen. In certain embodiments, the outlet to remove a third product stream comprises a V-shaped base. In these embodiments, the V-shaped based is capped with a preferably oval shaped screw feed which is preferably inverted to remove char optionally comprising an inlet for providing an inert gas to reduce or prevent oxygen from entering the process of the present invention. Advantageously, a V-shaped base can provide easier feeding of char to the burner to heat the process of the present invention.

In some embodiments, the apparatus comprises a fractionator column in fluid communication with the at least one flash tank.

In some embodiments, the apparatus comprises a burner system, preferably in fluid communication with the fractionator column.

In some embodiments, the apparatus further comprises a thermal oxidiser in fluid communication with the burner system.

In certain embodiments, the pyrolysis reactor vessel comprises a pressure release seal. In some embodiments, the pressure release seal is between the pyrolysis reactor vessel and the pyrolysis oil condenser. Advantageously, this can provide safety to an operator while maintaining a substantially oxygen free environment of the pyrolysis reactor vessel.

In the process of the present invention, typically the pyrolysis gasses passing through the water-cooled stack condenser and Pyr-oil condenser are reduced back to diesel (D975), kerosene (D3699) and petrol (D4814) hydrocarbon fuels. In these embodiments, typically olefins decreased while saturated paraffins increased. These hydrocarbon fuels are then removed from the process via a slip catch system which has the potential to be upgraded to standard fuels or blended with crude/fuel oil products via flash drums, fractionator and blending equipment. What is not caught by the slip catch system returns to the pyrolysis reactor vessel into the reactor zone for further cracking. This is explained through secondary cracking of liquid products, which has a higher activation energy compared to the initial cracking.

In some embodiments, the apparatus of the present invention further comprises a recycle stream. In some embodiments, the recycle stream is downstream of the pyrolysis reactor vessel to the feed inlet (preferably a feed screw). In some embodiments, the recycle stream is downstream of the condenser to the feed inlet (preferably a feed screw). In some embodiments, the recycle stream is downstream of the flash tank to the feed inlet. In some embodiments, the recycle stream is downstream of the outlet (preferably a side draw) to the feed inlet. In some embodiments, the recycle stream is downstream of the product blending tank to the feed inlet. In some embodiments, the recycle stream is downstream of the bottom product tank to the feed inlet. In some embodiments, the recycle stream is downstream of the fractionator column (preferably located at the bottom of the fractionator column) to the feed inlet.

In some embodiments, the recycle stream is downstream of the condenser to the pyrolysis reactor vessel. In some embodiments, the recycle stream is downstream of the flash tank to the pyrolysis reactor vessel. In some embodiments, the recycle stream is downstream of the outlet (preferably a side draw) to the pyrolysis reactor vessel. In some embodiments, the recycle stream is downstream of the product blending tank to the pyrolysis reactor vessel. In some embodiments, the recycle stream is downstream of the bottom product tank to the pyrolysis reactor vessel. In some embodiments, the recycle stream is downstream of the fractionator column (preferably located at the bottom of the fractionator column) to the pyrolysis reactor vessel.

In another aspect, the present invention provides a containerised plant comprising: a plurality of independent modules, wherein each module comprises components, such that the components of the independent modules form a containerised plant when assembled. This can provide unlimited expansion in plastic process volume, for example, by including additional pyrolysis reactor vessels to work in tandem (either series or parallel) with each other.

The present invention can provide at least one of the following advantages:
Relocatable/portability;
Ability to tie-in to customer sites;
Minimal, if any civil work required;
Easily scalable;
Can be automated; and
Easier commercial roll out compared to fixed plants.

### Definitions

In describing and claiming the present invention, the following terminology will be used in accordance with the definitions set out below. It is also to be understood that the terminology used herein is for the purpose of describing particular embodiments of the invention only and is not intended to be limiting. Unless defined otherwise, all technical and scientific terms used herein have the same meaning as commonly understood by one having ordinary skill in the art to which the invention pertains.

Unless the context clearly requires otherwise, throughout the description and the claims, the words “comprise”, “comprising”, and the like are to be construed in an inclusive sense as opposed to an exclusive or exhaustive sense; that is to say, in the sense of “including, but not limited to”.

As used herein, the phrase “consisting of” excludes any element, step, or ingredient not specified in the claim. When the phrase “consists of” (or variations thereof) appears in a clause of the body of a claim, rather than immediately following the preamble, it limits only the element set forth in that clause; other elements are not excluded from the claim as a whole. As used herein, the phrase “consisting essentially of” limits the scope of a claim to the specified elements or method steps, plus those that do not materially affect the basis and novel characteristic(s) of the claimed subject matter.

With respect to the terms “comprising”, “consisting of”, and “consisting essentially of”, where one of these three terms is used herein, the presently disclosed and claimed subject matter may include the use of either of the other two terms. Thus, in some embodiments not otherwise explicitly recited, any instance of “comprising” may be replaced by “consisting of” or, alternatively, by “consisting essentially of”.

Other than in the operating examples, or where otherwise indicated, all numbers expressing quantities of ingredients or reaction conditions used herein are to be understood as modified in all instances by the term “about”. The examples are not intended to limit the scope of the invention. In what follows, or where otherwise indicated, “%” will mean “weight %”, “ratio” will mean “weight ratio” and “parts” will mean “weight parts”.

The term ‘substantially’ as used herein shall mean comprising more than 50% by weight, where relevant, unless otherwise indicated.

The recitation of a numerical range using endpoints includes all numbers subsumed within that range (e.g., 1 to 5 includes 1, 1.5, 2, 2.75, 3, 3.80, 4, 5, etc.).

The terms “preferred” and “preferably” refer to embodiments of the invention that may afford certain benefits, under certain circumstances. However, other embodiments may also be preferred, under the same or other circumstances. Furthermore, the recitation of one or more preferred embodiments does not imply that other embodiments are not useful and is not intended to exclude other embodiments from the scope of the invention.

It must also be noted that, as used in the specification and the appended claims, the singular forms “a”, “an” and “the” include plural referents unless the context clearly dictates otherwise.

As used herein, the term ‘pyrolysis’ refers to the conversion of carbonisable materials, such as plastic materials, to gas and/or liquid residues without combustion or oxidation.

As used herein, the term ‘decompose’ and the like refers to the break down or ‘cracking’ of the molecules in the plastic material into smaller molecules (lower molecular weight).

As used herein, the term ‘condensing’, ‘condense’ and the like refers to a physical change of state from a gaseous phase to a liquid or a solid phase and combinations thereof.

As used herein, the term ‘cracking’ refers to reducing the carbon chain length of hydrocarbon compounds, such as the hydrocarbon compounds in the plastic material.

As used herein ‘non condensable gases’, ‘non-condensables’ and the like refer typically to hydrogen, carbon monoxide, carbon dioxide, nitrogen or other inert in gases, methane, ethane, and more generally hydrocarbons having between 1 to 4 carbon atoms. These are typically in gaseous phase at 25° C. under atmospheric pressure.

Light hydrocarbons are typically hydrocarbons having boiling point below 150° C. under atmospheric pressure or comprising less than 9 carbon atoms.

Heavy hydrocarbons are typically hydrocarbons having boiling point between 140° C. (or 150° C.) and 380° C., under atmospheric pressure or comprising between 9 and 25 carbon atoms. Typically, heavy products obtained from distillation of pyrolysis gases are suitable for use in diesel blending.

The prior art referred to herein is fully incorporated herein by reference.

Although exemplary embodiments of the disclosed technology are explained in detail herein, it is to be understood that other embodiments are contemplated. Accordingly, it is not intended that the disclosed technology be limited in its scope to the details of construction and arrangement of components set forth in the following description or illustrated in the drawings. The disclosed technology is capable of other embodiments and of being practiced or carried out in various ways.

### BRIEF DESCRIPTION OF THE DRAWINGS

Preferred embodiments of the invention will now be described, by way of example only, with reference to the accompanying drawings in which:

FIGS. 1-5 shows an embodiment of a process flow diagram for the process of the present invention for producing a hydrocarbon fuel from a plastic material feedstock.

FIG. 6 shows a simplified process flow diagram for the process of the present invention for producing a hydrocarbon fuel from a plastic material feedstock based on the embodiment of FIGS. 1-5.

FIGS. 7-8 are a boiling point curve comparison graphs of the pyrolysis oil obtained in one embodiment of the present invention (MWP PyrOil) compared with ASTM standard fuels. Volume and mass percentages are not analogous and this is a representative comparison only.

### DETAILED DESCRIPTION OF THE INVENTION

The skilled addressee will understand that the invention comprises the embodiments and features disclosed herein as well as all combinations and/or permutations of the disclosed embodiments and features.

### EXAMPLES

### Example 1—Process for Producing a Hydrocarbon Fuel from a Plastic Material Feedstock

A typical process for producing a hydrocarbon fuel from a plastic material feedstock is described herein. The process can comprise the following:
Shredding/washing/drying;
Sorting;
Reactor;
Separation;
Fractionation;
Scrubber;
Burner system;
Water cooling system;
Generator; and
Air compressor.

### Shredding/Washing/Drying

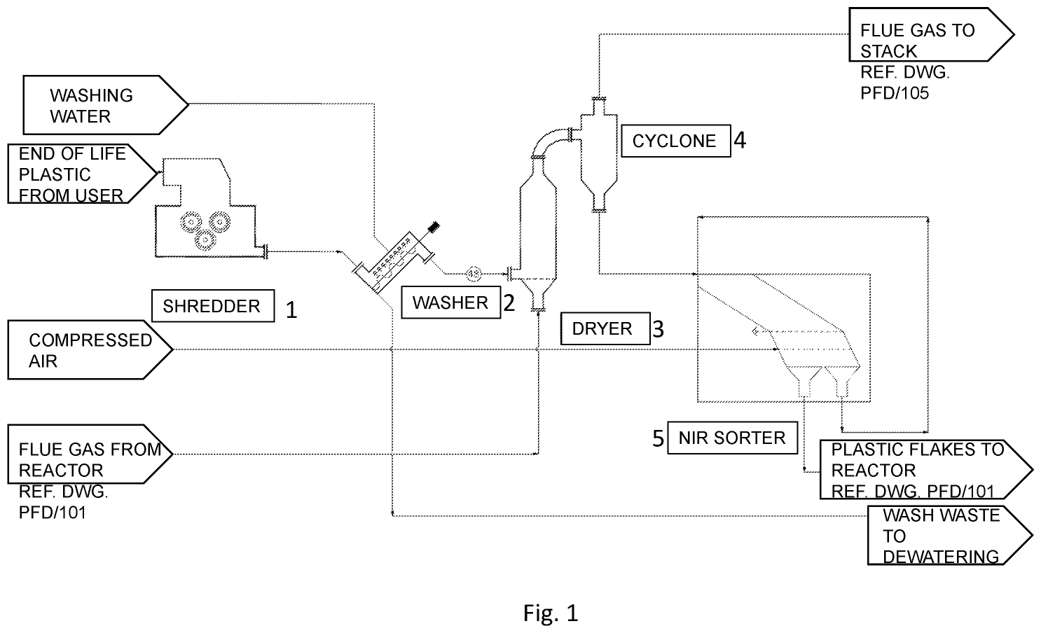

Referring to FIG. 1, the feedstock of plastic material (plastic waste) is fed into a shredder (1) which shreds the incipient plastic waste to comminuted plastic material in the form of plastic flakes having a size between 15-25 mm (average diameter) as this range can be readily accepted by off the shelf commercial sorters. The plastic flakes are then fed from the shredder into a washer (2). Given the contamination of such plastic washing can remove the grit and loose contamination of the plastic material feedstock. The flakes are washed using water whilst being agitated, all heavy and large contaminants such as metal scrap exit an underflow of the washer. The washed flakes are then fed from the washer (2) into a dryer (3). The dryer is a fluidised bed dryer where flue gas is used as the fluidising medium. As the flakes are dried, the dried plastic flakes exit the top of the dryer (3) due to reduced density. The plastic flakes are then separated from the flue gas through a cyclone (4), where they drop into the feeder of a near infrared (NIR) sorter (5). In some embodiments, it is preferable that all obvious signs of contamination, i.e. large pieces of metal/food or other contaminants are removed prior to the shredder.

### Sorting

Prior to the shredding step, a mixed waste feedstock (such as municipal waste) can be physically sorted to remove unwanted material such as nappies and the like. Additionally, a scalping screen can be used to sorts small foreign objects before passing over a screen in which flat materials such as cardboard pass over while other materials drop through the screen. The material which has dropped through can contact another screen that breaks any glass materials such as bottles, which also passes through a screen and is taken for recovery.

This leaves the cans, metals and plastic containers. A magnet can be used to remove ferrous-based metal impurities. As the presence of metals can have adverse effects on the process of the present invention, ferrous metals can be optionally removed before feeding the pyrolysis reactor vessel using a magnet. In these embodiments, the magnet can be selected from the group consisting of a permanent magnet or electromagnet.

In other embodiments, sorting can further comprise an X-ray based spectrometer such as X-ray fluorescence or X-ray transmission, an eddy current separator, a wet-mechanical separator (also known as dense media separation), flotation, mechanical separation such as a grill/screen which optionally vibrates; and combinations thereof to remove non-ferrous metals from the plastic feedstock.

Typically, after this sorting step, plastic feedstock remains for shredding to provide plastic flakes as discussed above.

The dried plastic flakes are conveyed into the sorter (5). The sorter (5) shines near-infrared light on the plastic flakes being conveyed. The sorter can differentiate between different plastic types based on their infrared adsorption/emission spectrum; this is referred to as their infrared ‘fingerprint’ with each plastic having a unique ‘fingerprint’. The reflected light ‘fingerprints’ the polymer of the plastic flakes. The plastic flakes are then sorted by ejecting the flakes of a certain wavelength through air pulsation jets/knives. The sorter splits incoming plastic flakes into polymers such as PET, PVC, PP/PE, PS, and others. The sorter (5) can also reject any severely contaminated plastics which can ‘poison’ the process of the present invention. The PET flakes can be recovered and sold to recycling centres or used in the process of the present invention. While the PP/PE and PS splits are sent to hoppers for storage until they are required in the process of the present invention. An additional benefit of a high throughput NIR sorter is the production of near-pure PET flakes with no constraint on the throughput of plastic feedstock into the pyrolysis reactor vessel.

### Reactor

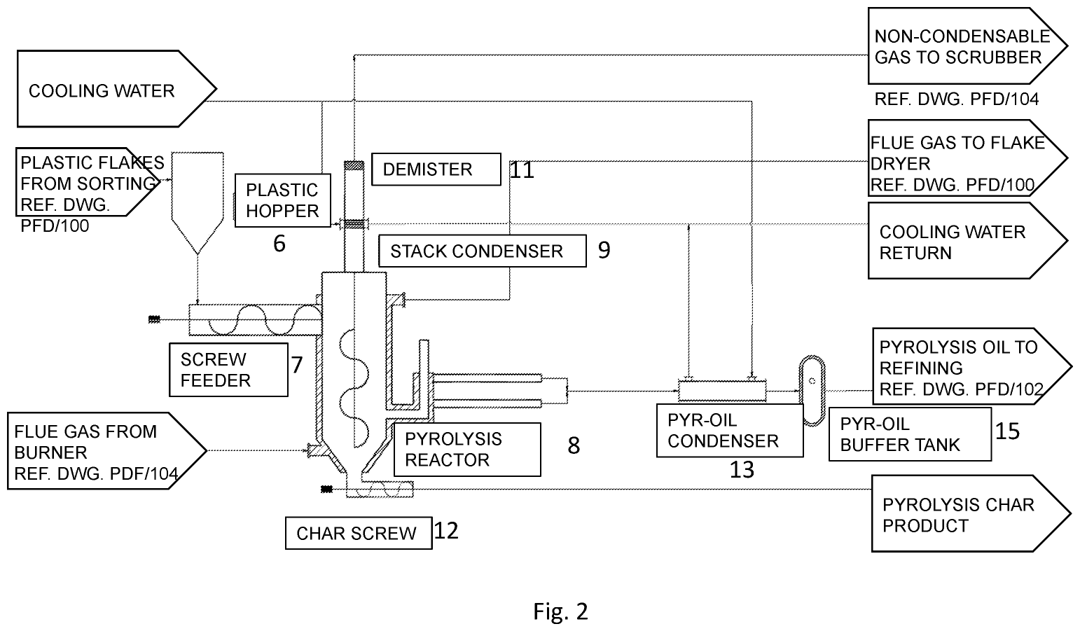

Referring to FIG. 2, the sorted plastic flakes then enter a hopper (6). From the hopper (6), the sorted plastic flakes are dropped into a screw feeder (7), which is heated externally through a jacket. The jacket is typically a channel surrounding or partially surrounding the screw feeder having a flow of hot gas such as flue gas from the burner system to melt the plastic flakes. Alternatively, the jacket can comprise a resistive heating element to heat the screw feeder to melt the sorted plastic flakes. The sorted plastic flakes can be heated and melted while being extruded into the pyrolysis reactor vessel (8). The feed melt temperature is controlled in excess of 200° C. to minimise shear within the screw of the screw feeder (7).

In some embodiments, the pyrolysis reactor vessel (8) is heated by a jacket partially or completely surrounding the vessel (i.e., indirect heating). In some embodiments, the jacket has a flow of hot gas such as flue gas from the burner system to melt the plastic in the pyrolysis reactor vessel. In other embodiments, the jacket comprises a heated fluid such as superheated water or oil.

Jackets can be a plain jacket, half pipe coil jacket, dimple jacket and the like.

The melted plastic is then introduced into the side of the pyrolysis reactor vessel (8) through a directional channel to prevent bypass of gases through the reactor. The melted plastic falls into the active reaction zone comprised of a bulk reaction melt. The bulk reaction melt is constantly agitated to prevent or reduce hot zones forming (promote isothermal conditions) and to promote mixing within the pyrolysis reactor vessel (8). In preferred embodiments, recycled pyrolysis oil can be injected into the screw feeder (7) to reduce viscosity of melt and improve heat transfer characteristics of the melt.

Gaseous products of the reaction disengage from the reaction melt and flow upwards into a stack condenser (9) which is integrated with the pyrolysis reactor vessel (8). This condenser can in some embodiments be a series of parallel tubes carrying water within the reactor stack. As longer chain hydrocarbons interact with the tubes, they are condensed back into the reactor whilst lighter non-condensable gases pass through to the scrubber (10) (as described below) via a demister (11). The condensed hydrocarbons flow back into the reaction melt where they can undergo secondary pyrolysis/cracking/chain-reduction and droplets of condensed hydrocarbons can also coalesce on the demister (11) before dropping into the reaction melt. This reduces the average chain length of the hydrocarbons present in the reaction melt.

In preferred embodiments, the condenser is a series of parallel tubes carrying cooling medium (coolant fluid). In another embodiment, the condenser is a spiral wound series of tubes carrying cooling medium.

Due to its higher density, the solids by-product (char, third product stream) of the pyrolysis reaction falls through the reaction melt until it is dropped into another screw feeder (12) at the bottom of the reactor. The solids by-product is then extruded through to storage, where it may be fed into the burner system (23) and recovered as heat by burning the char.

The pyrolysis product comprising hydrocarbon fluid flows as a gas/liquid mixed phase through to the side arm of the pyrolysis reactor vessel (8) and enters a pyr-oil condenser/pyrolysis oil condenser (13), where it is condensed and cooled to between 100-400° C., preferably 100-150° C. The pyrolysis oil product then proceeds to a first effect flash tank (14) via a pyr-oil buffer tank (15).

### Separation

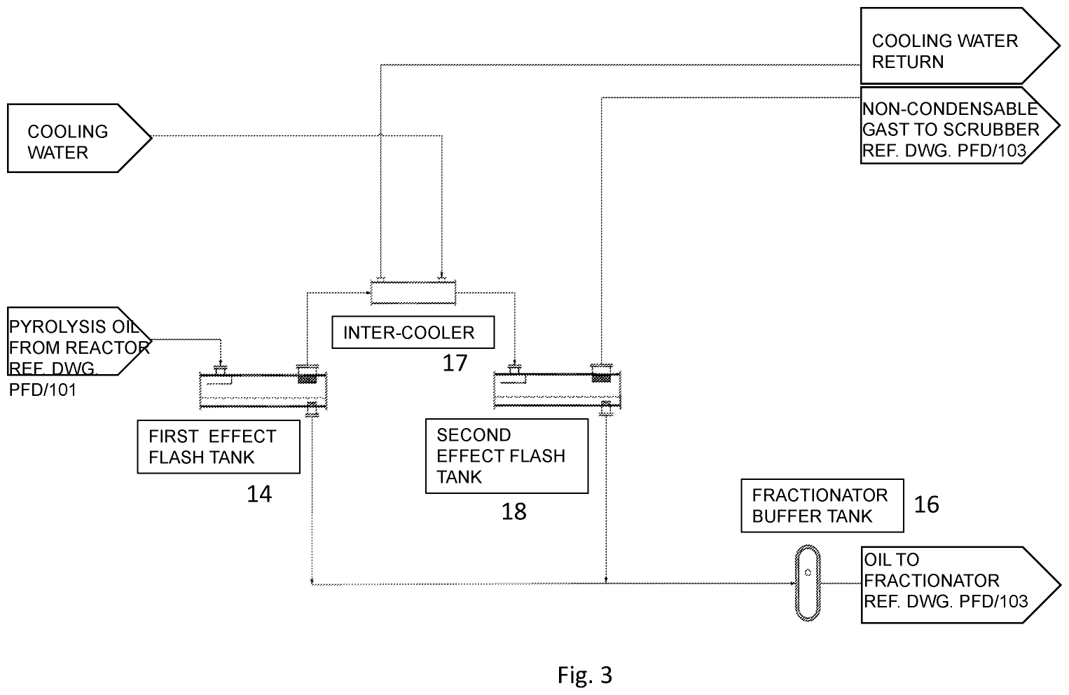

Referring to FIG. 3, the pyrolysis oil product flows into the first effect flash tank (14) where the separation of non-condensables from the oil occurs. Volatile hydrocarbons are flashed off, with any of the heavier hydrocarbons coalescing on the mist eliminator of the tank. The resulting liquid product portion flows to the fractionator buffer tank (16). The vapour product portion flows through a jacketed intercooler (17) before entering a second effect flash tank (18). The second effect flash tank (18) behaves in a similar manner to the first effect flash tank (14) to provide greater separation between the lighter and heavier hydrocarbons. The liquid product portion from the second effect flash tank (18) flows to the fractionator buffer tank (16). The vapour product portion from the second effect flash tank (18) flows to the scrubber (10). The flash vessels separates the non-condensable gases from the pyrolysis oil.

### Fractionation

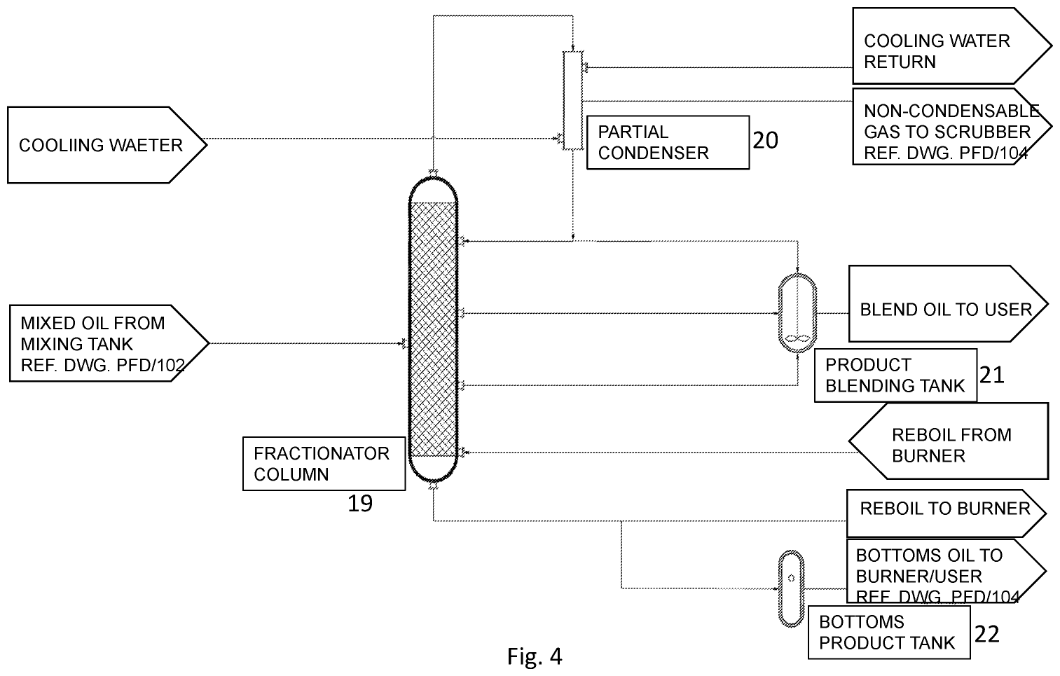

Referring to FIG. 4, from the fractionator buffer tank (16), the liquid (oil) enters a packed bed fractionator column (19). The lighter and more volatile of the hydrocarbons flow upwards through the column, while the heavier and less volatile flow downwards. The vapour product portion is introduced to a spiral wound water-cooled heat exchanger which acts as a partial condenser (20). The non-condensable products from the heat exchanger flow to the scrubber (10). The condensed heavier products flow to product blending tank (21). The column has several side-draws in addition to the overhead product stream, which all report to the product blending tank (21) to form the first product stream comprising a hydrocarbon fluid formed from pyrolysis to provide a hydrocarbon fuel. The flow rates of these streams are controlled through throttling, which ensures selectivity in the product blend of the first product stream. The fractionator column (19) separates the pyrolysis oil into different hydrocarbon fractions.

The column bottom's stream is split between a bottom's product and a boil-up. The boil-up is pumped to the boil-up coil within the burner system before being reintroduced back to the column. The boil-up circuit is separate from the column (19) and is pumped through to the burner system (23). The bottom's product flows to the bottom product tank (22). The bottom's product has the potential to be used within the burner system as a fuel or sold as a heating oil.

### Scrubber

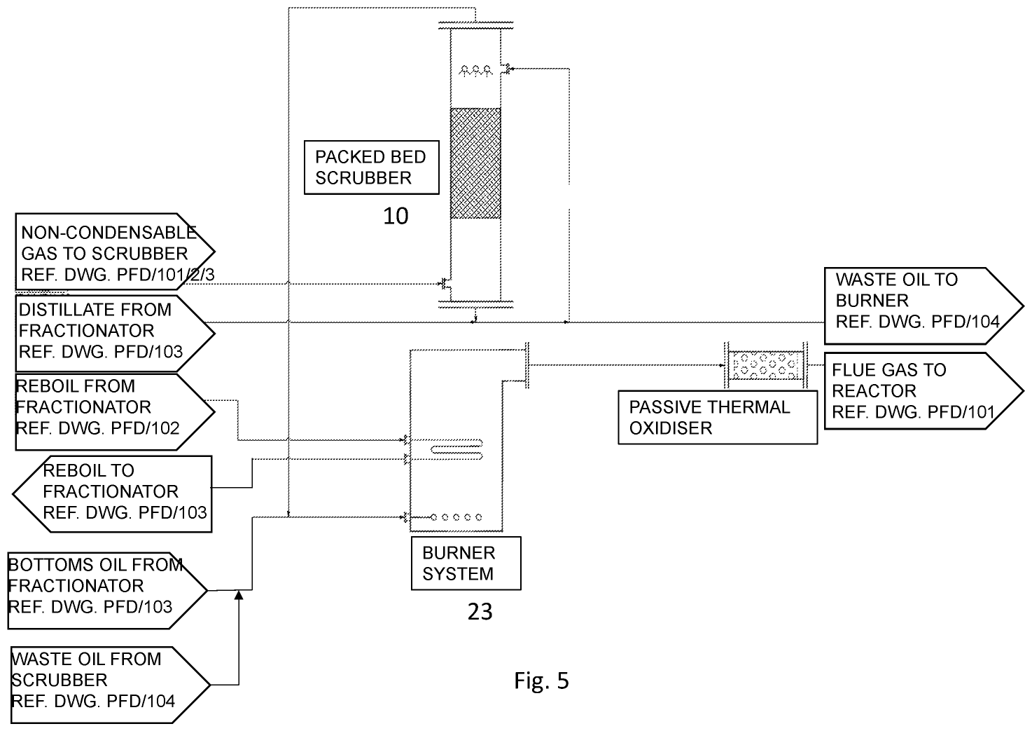

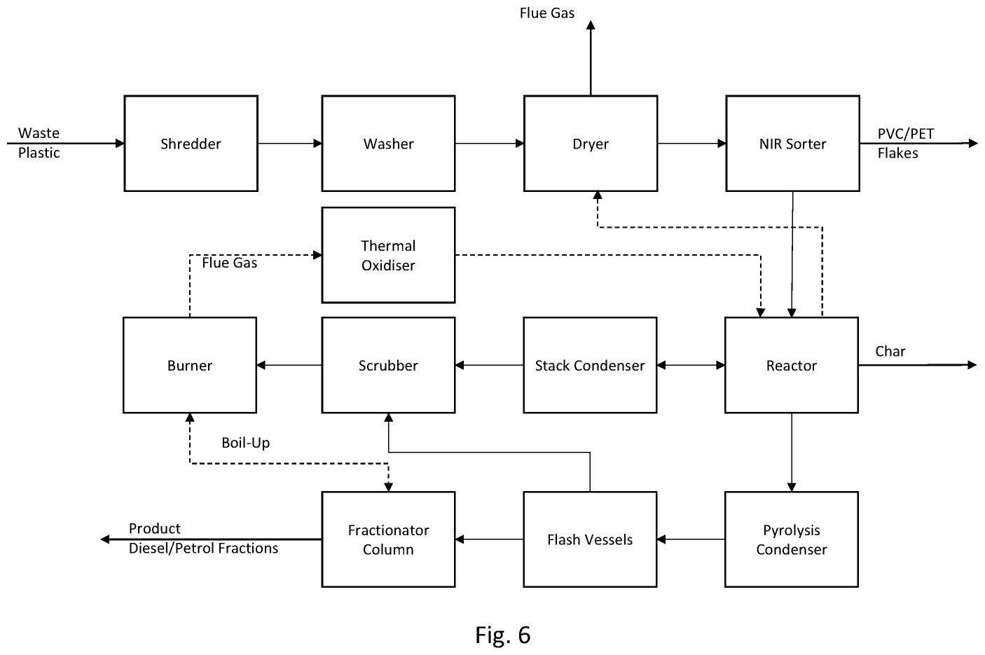

Referring to FIG. 5, the non-condensable vapours from the pyrolysis reactor vessel (8), the second effect flash tank (18), and the distillation column (19) enter a packed bed scrubber (10) to remove impurities. As the vapour travels upwards through the column of the scrubber (10), the vapour comes into contact with a scrubbing liquor. Along the length of the column of the scrubber (10), the miscible components of the vapour are scrubbed into a liquor and drop to an internal sump. This liquor is recycled with a continuous bleed to ensure stable operation. The waste scrubbing liquor and scrubbed vapour are sent to the burner system (23).

The vapour product portions of the process of the present invention comprising volatile hydrocarbons which flow to the scrubber (10) form the second product stream. In some embodiments, the second product stream can be a gas (vapour), liquid or combinations thereof.

### Burner System

The burner system (23) comprises a mixed fuel burner with a passive thermal oxidiser. The scrubber vapour is the main fuel source for the burner system, with the bottom's oil from the fractionator column (19) and waste scrubbing liquor from the scrubber (10) being oxidised to limit emittance of harmful volatile organic compounds (VOCs). The flue-gas emitted from the burner system can be used as a heat source for the boil-up coil of the fractionator column (19), and the main heat source for the pyrolysis reactor vessel (8). In preferred embodiments, the flue gas from the burner system (23) provides the inert substantially oxygen free and about atmospheric environment of the pyrolysis reactor vessel (8). In certain embodiments, the char product from the pyrolysis reactor vessel (8) can be fed into the burner system (23) to reduce solids by-products from the process of the present invention and enable additional heat recovery.

The flue gas passes through the burner system (23) into a passive thermal oxidiser, which is comprised of a packed ceramic bed. This allows full oxidation of any residual VOCs or any partially oxidised products from combustion. After passing through the thermal oxidiser, the flue gas returns to the pyrolysis reactor vessel (8) providing all the heat for the reaction/process before passing through a flue gas stack and into the atmosphere. In preferred embodiments, the flue gas provides heat for drying of the washed plastic flakes.

### Water Cooling System

The cooling water or any other suitable coolant used in the condensers of the present invention and heat exchangers in the plant/apparatus is recirculated by a water cooler or equivalent, which in the preferred embodiment is a forced draught finned tube heat exchanger.

### Generator

The electricity required by the present invention to power equipment such as pumps, lighting, and controls can be supplied by any suitable generator (for example a packaged diesel generator) within the apparatus. Advantageously, synthetic fuel produced from the process of the present invention can be directly integrated back into powering the equipment/components of the apparatus. For initial start-up of the apparatus, an initial dose of diesel can be used until the first synthetic diesel product is produced from the process of the present invention. Alternatively, the present invention can be powered externally from the grid or other renewable sources.

The capacity of the generator can be tailored to consume all synthetic diesel product from the process to function as a portable generator.

In one embodiment, the generator capacity for the complete load of synthetic diesel produced is approximately 6,845 to 11,400 kWh/day. This assumes a 60% conversion of incipient plastic feedstock into pyrolysis oil, and a 60% recovery of synthetic diesel from the pyrolysis oil, and a diesel generator with 30-50% efficiency. Given the average household electricity use of 41.1 kWh/day, one integrated system could provide power to 166-277 houses per day.

### Air Compressor

Similar to the diesel generator above, a packaged diesel air compressor can in some embodiments provide the compressed air for the apparatus. The compressed air can primarily be used in the NIR sorter for the air knives ejecting reject material. The compressed air can also be used throughout the apparatus for powering of pneumatic control valves.

### Example 2—Modules and Plant Design

The processing plant can be provided in some embodiments using three 40-ft iso (intermodal) containers as they can provide flexibility of delivery to different locations and scaling options.

Two containers can function as semi-permanent or permanently situated plant. These modules can be installed side-by-side lengthways to minimise plant footprint and to ensure process and piping interfaces.

The third container can function as a ‘return to sender’ delivery of process equipment only. The third container can contain the towers/tower-like structures to allow ease and safety of shipping, especially regarding oversize loads. Due to the prospective height of the pyrolysis reactor stack, fractionator column, flue gas stack and gas scrubber, these components can be packed in this container rather than shipping the components pre-installed to prevent damage.

TABLE 1
summarises a preliminary shipping concept of the equipment
breakdown within the three 40-ft container modules.
Potential allocation of equipment for shipping.

| Module A | Module B | Module C (delivery- |
|---|---|---|
| Plastic Conditioning | Reactor and | only) |
| and Ancillaries | Beneficiation Equipment | Tall Items |
| Shredder | Reactor system | Flue gas stack |
| Washer | Buffer tanks | Packed bed scrubber |
| Dryer and cyclone | Flash tanks | Fractionator column |
| NI R sorter | Condensers/intercoolers | Burner system |
| Air compressor | Blending tanks | Water cooler |
| Generator | Screw feeder/char screw | Passive thermal |
| | | oxidiser |
| Plastic hopper | | Reactor stack |

TABLE 2
summarises a preliminary installation concept of the
equipment breakdown once the plant/apparatus is constructed.
Potential allocation of installed equipment. The plant/apparatus
would fit into the two semi-permanent containers installed
side-by-side lengthways.

| Module A | Module B | Outside the |
|---|---|---|
| Plastic Conditioning | Reactor and | Modules |
| and Ancillaries | Beneficiation Equipment | Ancillaries |
| Shredder | Reactor system | Water cooler |
| Washer | Buffer tanks | Passive thermal |
| | | oxidizer (option 2) |
| Dryer and cyclone | Flash tanks | |
| NIR sorter | Condensers/intercoolers | |
| Air compressor | Blending tanks | |
| Generator | Screw feeder/char screw | |
| Flue gas stack | Burner system/Passive | |
| | thermal oxidiser (option 1) | |
| Plastic hoppers | Packed bed scrubber | |

### Example 3—Experimental Results

The expected yields based on initial studies of the process of the present invention are about 57-77% liquid, 9-28% gas and 0-14% char on a mass basis as shown in Table 3. The assumed theoretical average yield for the concept of the present invention was 60 w/w % liquid: 26 w/w % gas: 14 w/w % char. From these assumed theoretical average yields, the oil yield from 1 tonne of sorted plastic will be about 600 kg (−750 L with an assumed density of 800 kg/m3). From the gas analysis of the initial results in Table 4, the gas product provides enough heating energy for the entire process including all ancillaries (based on an estimated gas lower heating value of approximately 13.2 to 43.1 MJ/kg).

TABLE 3
Experimental yields of the process of the present invention
Yields (%)

| Plastic type | Liquid | Gas | Residue (char) |
|---|---|---|---|
| PET | 0 | 100 | 0 |
| HDPE | 62.7 | 24.4 | 12.9 |
| LDPE | 77.1 | 8.6 | 14.3 |
| PP | 66 | 34 | 0 |
| PS | 66 | 21.1 | 12.9 |
| MWP^{a} | 57.3 | 28.4 | 14.3 |

^{a}Simulated municipal waste plastic

The products of the pyrolysis process can depend on operating conditions and while the yields of the hydrocarbon products may be similar, the chemical composition of the products can be different. Typically, the PE feedstocks resulted in the liquid being described as waxy throughout, with tendency to solidify at room temperature. These results show that an embodiment of the reactor configuration of the present invention gives similar results to lab scale experiments (samples of under 100 g), and is a good indication that further scaling would show similar yields

TABLE 4
Experimental results for gas composition
using process of the present invention

| | Plastic type | | | | |
|---|---|---|---|---|---|
| | LDPE | PP | HDPE | LDPE | HDPE |
| | Draw location | | | | |
| | | | Bottom | | Bottom |
| | Lower | Bottom | Tower | Top | tower |
| | tower | tower | (Run 1) | tower | (Run 2) |
| Gas | mol % | | | | |
| carbon dioxide | 7.31 | 14.35 | 14.11 | 1.58 | 1.98 |
| carbon monoxide | 4.28 | 10.37 | 10.38 | 0 | 1.99 |
| helium | 0 | 0 | 0 | 0 | 0 |
| hydrogen | 5.78 | 1.46 | 2.14 | 1.33 | 2.79 |
| hydrogen sulfide | 0 | 0 | 0 | 0 | 0.13 |
| nitrogen | 6.78 | 14.79 | 19.60 | 57.43 | 29.39 |
| oxygen | 1.20 | 3.69 | 2.23 | 15.18 | 4.94 |
| methane | 9.47 | 6.95 | 5.22 | 1.37 | 7.35 |
| ethane | 7.95 | 5.24 | 4.81 | 2.16 | 6.15 |
| ethylene | 12.34 | 7.41 | 6.20 | 2.89 | 10.63 |
| acetylene | 0.05 | 0 | 0 | 0.01 | 0 |
| propane | 7.48 | 3.73 | 5.37 | 2.73 | 5.49 |
| propadiene | 0 | 0 | 0 | 0 | 0.14 |
| propylene | 11.46 | 12.75 | 7.74 | 3.82 | 9.82 |
| methyl acetylene | 0.07 | 0.03 | 0.06 | 0 | 0.04 |
| isobutane | 0.13 | 0.16 | 0.15 | 0.06 | 0 |
| n-butane | 3.73 | 1.43 | 2.95 | 1.71 | 2.53 |
| trans-2-butene | 0 | 0.45 | 0.90 | 0.35 | 0.80 |
| 1-butene | 0.78 | 1.77 | 2.73 | 2.12 | 3.13 |
| isobutylene | 5.22 | 2.89 | 1.65 | 0.91 | 1.39 |
| cis-2-butene | 2.13 | 0.33 | 0.68 | 0.26 | 0.60 |
| 1,3-butadiene | 1.39 | 0.89 | 0.74 | 0.57 | 1.24 |
| n-pentane | 1.97 | 3.43 | 1.92 | 1.16 | 0.10 |
| 2-methyle-2- | 0.40 | 0.71 | 0.64 | 0 | 0.39 |
| butene | | | | | |
| 1-pentene | 0.16 | 0.17 | 0.21 | 1.83 | 1.15 |
| 2,2- | 0.44 | 0.01 | 0.04 | 0.02 | 0.03 |
| dimethylpropane | | | | | |
| isopentane | 0.03 | 0.03 | 0.09 | 0.03 | 0.05 |
| trans-2-pentene | 0.21 | 0.16 | 0.20 | 0.08 | 0.20 |
| cis-2-pentene | 4.88 | 3.35 | 5.23 | 0.32 | 4.48 |
| C6+ | 4.35 | 3.42 | 4.02 | 2.09 | 3.08 |

Table 4 is the analysis of the gas composition from the pyrolysis of poly-olefinic compounds namely: LDPE, HDPE, and PP. The high nitrogen and oxygen content are likely due to sampling and/or experimental error within the gas chromatograph. The high concentrations of ethene and propene are indicators of primary cleavage of the polymer chains as these are the monomers of the plastics pyrolysed. The presence of 1,3-butadiene is indicative of the formation of cycloalkanes, cycloalkenes and aromatics in the reactor; the reaction of butadiene with other alkenes can lead to the cyclisation of hydrocarbons.

The presence of hydrogen indicates that there is free-radical chemistry, which can also lead to the cyclisation of hydrocarbons and increases the reaction rate of pyrolysis. The low concentration of C6+ hydrocarbons is resultant from the condensing section of the reactor, as any species above pentene is typically condensed from the gas stream. The gas analysis shows that there is the potential to capture the gas from the reaction and use it for heating purposes in a burner system.

The pollutants from the process of the invention can be dependent on the quality of the plastic used as the feedstock. The presence of metals or organics in the plastic feedstock can have adverse effects on the process; metals would typically be removed before entering the plastic conditioning section, with ferromagnetic metals being removed using magnets. Most of the contamination, including organic contamination, of the plastics can be removed in the washing and sorting stages within the plastic conditioning section of the plant. The major pollutants formed within the apparatus can be flue gas from the burner. The burner system of the present invention could ensure that the only potential pollutant will be carbon dioxide from the system with 0.85 tonnes CO₂ emitted per tonne of plastic feedstock entering the pyrolysis reactor vessel.

The apparatus/plant of the present invention can be automated using a locally mounted programmable logic controller (PLC) to control the process and enable remote monitoring. The client-side operator(s) can load plastic feedstock as needed such as a few times per day, remove the char by-product, and maintain the rig (e.g. clear blockages). As a result of automation, there is no requirement for constant monitoring, as alarms can be automatically raised to alert operators when their above-mentioned duties are required.

The automation can also provide steady system operation within the design operating range, and includes safety measures such as emergency shut-downs to ensure that the apparatus is protected from deviations.

The process of the present invention can produce a saleable product either as a near-diesel product or can be further refined/upgraded and/or blended. The resulting hydrocarbon fuel products of the present invention can produce oils that are a mixture of hydrocarbons from petroleum, kerosene and diesel fractions and benchmarked using ASTM standards for diesel (D975), kerosene (D3699), and petrol (D4814) to determine feasibility of product specification. The ASTM standards specifications are shown in Table 5 to Table 7.

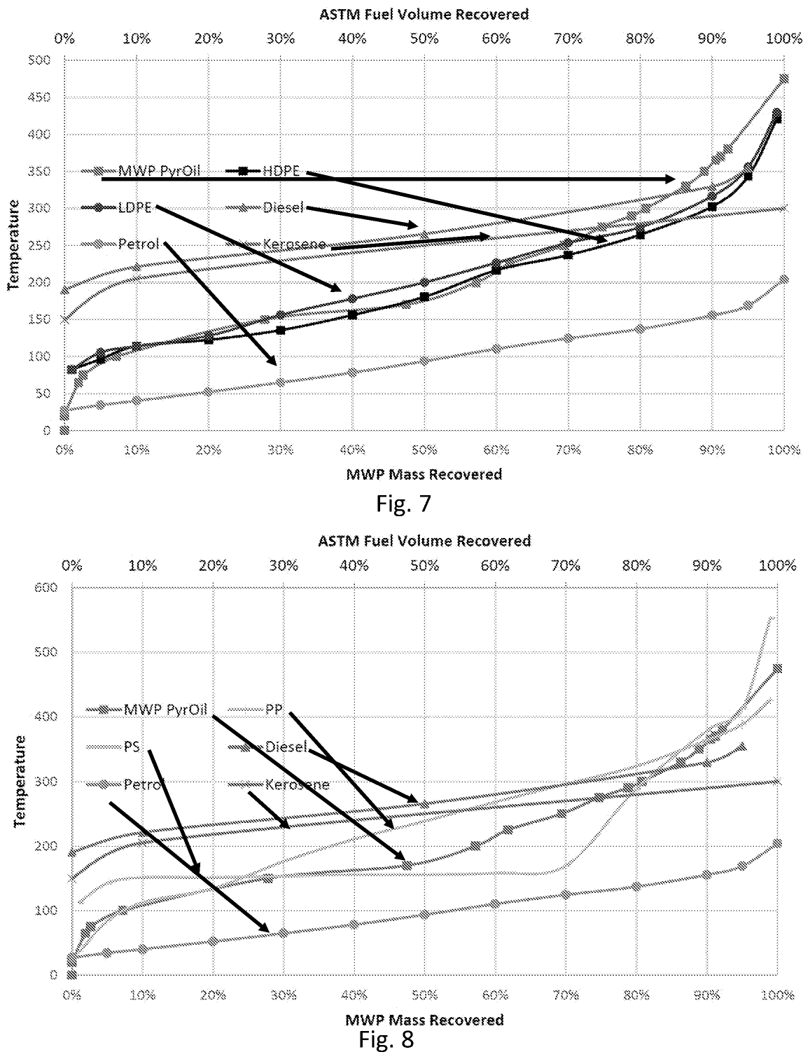

The initial characterisation results of the pyrolysis oil from the process of the present invention were applied to the ASTM specifications to determine their suitability. It was found that the simulated mixed waste plastic pyrolysis oil displays a distillation curve indicative of the presence of all three hydrocarbon fuel fractions as shown in FIGS. 7-8 (it is to be noted that volume and mass percentages are not analogous and for FIGS. 7-8, the graphs are a representative comparison only).

It was found that the physical characteristics of the hydrocarbon fuel products produced by the process of the present invention met some of specifications of each of the different ASTM fuel standards. This result shows promise for the pyrolysis oil to also be used as a blend oil or to undergo fractioning and further processing into respective fuel fractions.

In particular, the inventors have found that the oils produced by the process of the present invention conform to most of the ASTM standards for diesel (D975) fuel and can be described as near-diesel. This shows that the pyrolysis oils could be upgraded to on-specification fuel by removing the lights from the mixture. These light-ends within the mixture also display boiling points typical of petroleum and kerosene fractions. Without being bound by any one theory, the present Applicant believes that the process of producing fuel specification diesel, that by-product would display petrol (gasoline) and kerosene like characteristics. This would allow these by-products from the beneficiation to be blended with other fuel sources to suit other needs.

The analysis of the pyrolysis oil from polypropylene FIG. 8 also shows characteristics of heavier hydrocarbons. This can be due to the oligomer of propylene having both saturated and unsaturated bonds, which causes propylene to act as both electro-and nucleophilic. That is, it is more reactive than ethylene due to the weakness of its double bond.

The activation energy for the pyrolysis of propylene is lower than polyethylene. This can result in the higher presence of heavies (waxes) within the start of sample collection due to the initial bond cleavages occurring before secondary cleavages can occur. The analysis of the simulated municipal waste plastic shown in Table 3 shows that the resulting pyrolysis oil is heavily influenced by the concentrations of polyethylene and polypropylene within the mixture, with the distillation curve being roughly in between the polyethylene and polypropylene. The deviations from the similar distillation profiles of the poly-olefinic plastics can be due to the introduction of polystyrene into the process of the present invention.

The inflexions on the MWP distillation curve at certain points such as 150° C. is due to the presence of polystyrene within the process (as shown in FIG. 8, the inflexions in the MWP graph match gradient changes in the polystyrene plot). This can also explains the lower initial boiling point, lower API gravity, and viscosity of the MWP compared to the polyolefins. As the aromatic hydrocarbons (toluene, benzene, etc) are excellent solvents for non-polar hydrocarbons, there is the potential for light hydrocarbons to be in solution rather than emitted as gas.

These solvents would typically reduce the viscosity of the oil. The presence of these organic solvents opens the possibility of a recycle stream to reduce the viscosity of the plastic melt and increase the internal heat transfer.

TABLE 5
ASTM standards

| | | | Grade | | | | |
|---|---|---|---|---|---|---|---|
| | | | Low | | Low | | |
| Test Method | | | Sulphur | | Sulphur | | |
| ASTM | ISO | Property | 1-D | 1-D | 2-D | 2-D | 4-D |
| D83 | 2719 | Flash Point, min | 100 | 100 | 126 | 126 | 131 |
| D2500 | — | Cloud Point, max | | | | | |
| D2709 | — | Trace Sediment, % vol max | 0.05 | 0.05 | 0.05 | 0.05 | 0.05 |
| D445 | 3104 | Kinematic Viscosity, cSt, 40° C., max | 1.3 | 1.3 | 1.9 | 1.9 | 5.5 |
| | | Kinematic Viscosity, cSt, 40° C., min | 2.4 | 2.4 | 4.1 | 4.1 | 24 |
| D482 | 6245 | Ash, wt %, max | 0.01 | 0.01 | 0.01 | 0.01 | 0.1 |
| D2622, | EN 24260 | Sulphur, wt ^{′)}/0, max | 0.05 | 0.5 | 0.05 | 0.5 | 2 |
| D4294 | | | | | | | |
| D130 | 2160 | Copper Corrosion, 3 hr @ 212° F., max | No. 3 | No. 3 | No. 3 | No. 3 | NR |
| D613 | 5165 | Cetane Number, min | 40 | 40 | 40 | 40 | 30 |
| D976 | 4264 | Cetane Index, min | 40 | NR | 40 | NR | NR |
| D287 | | API Gravity (60/60), max | | | 38 | 38 | — |
| | | API Gravity (60/60), min | | | 34 | 34 | — |
| D524 | 10370 | Ramsbottom Carbon Residue on 10% | 0.15 | 0.15 | 0.35 | 0.35 | NR |
| | | Distillation Residue, % mass, max | | | | | |
| | | Distillation, % Volume Recovered, ° F. | | | | | |
| D86 | 3405 | IBP | | | 190.6 | 375 | — |
| | | 10% | | | 221.1 | 430 | — |
| | | 50% | | | 265.6 | 510 | — |
| | | 90% | 550 | 550 | 329.4 | 625 | NR |
| | | 95% | | | 355 | 671 | — |
| | | Recovered Volume, % min | | | 98% | 98% | — |

| | | Plastic | | | | |
|---|---|---|---|---|---|---|
| Test Method | | | | MWP | | |
| ASTM | ISO | HDPE | LDPE | simulated | PP | PS |
| D83 | 2719 | 20 | 20 | 20 | 20 | 20 |
| D2500 | — | 11 | 10 | 19 | −10 | 10 |
| D2709 | — | 0.05 | 0.05 | 0.4 | 0.025 | 0.025 |
| D445 | 3104 | 2.5 | 1.034 | 0.9973 | 1.394 | 1.204 |
| D482 | | 0.003 | 0.001 | 0.003 | 0.001 | 1.652 |
| D2622, | 6245 | 0.259 | 0.051 | 0.262 | 0.0148 | 0.0228 |
| D4294 | EN 24260 | | | | | |
| D130 | | — | | | | |
| D613 | 2160 | — | | | | |
| D976 | 5165 | — | | | | |
| D287 | 4264 | 53.7 | 52.7 | 44.7 | 49.8 | 21.9 |
| D524 | | — | | | | |
| | | Distillation, % Mass Recovered, ° C. | | | | |
| D86 | 10370 | 82.5 | 82.5 | 36.1 | 36 | 112.5 |
| | | 114 | 114 | 117.7 | 112.5 | 151 |
| | | 180.5 | 200 | 176.1 | 238.5 | 155.5 |
| | 3405 | 302.5 | 316.5 | 360.6 | 364 | 378.5 |
| | | 343.5 | 356 | 401 | 388.5 | 413 |

TABLE 6
ASTM standards

| Test Method | | | Grade | |
|---|---|---|---|---|
| ASTM | ISO | Property | 1-K | 2-K |
| D56 | | Flash Point, ° C., min | 38 | 38 |
| D2386 | | Freezing Point, ° C., max | −30 | −30 |
| D445 | 3104 | Kinematic Viscosity, cSt, 40° C., | 1.9 | 1.9 |
| | | max | | |
| | | Kinematic Viscosity, cSt, 40° C., | 1 | 1 |
| | | min | | |
| D1266 | EN | Sulphur, wt %, max | 0.04 | 0.3 |
| | 24260 | | | |
| D130 | 2160 | Copper Corrosion, 3 hr @ 212° F., | No. 3 | No. 3 |
| | | max | | |
| D3227 | | Mercaptan sulphur, wt %, max | 0.003 | 0.003 |
| D187 | | Burning Quality, min | pass | pass |
| D156 | | Saybolt Colour, min | +16 | +16 |
| | | Distillation, % Volume Recovered, ° C. | | |
| D86 | 3405 | 10% volume recovered, max | 205 | 205 |
| | | FBP, max | 300 | 300 |

TABLE 7
ASTM standards

| Test Method | | | Grade | | | | | | Plastron Initial | | |
|---|---|---|---|---|---|---|---|---|---|---|---|
| ASTM | ISO | Property | AA | A | B | C | D | E | Experimental Results | | |
| D4954, D5191, | | Vapor Pressure at 37.8° C. max, | 54 | 62 | 69 | 79 | 93 | 103 | | | |
| D5482, D6378 | | kPa | | | | | | | | | |
| D86 | 3405 | Distillation, % Volume Recovered, ° C. | | | | | | | HDPE | LDPE | MWP |
| | | 10%, max | 70 | 70 | 65 | 60 | 55 | 50 | 114 | 114 | 117.78 |
| | | 50%, min | 77 | 77 | 77 | 77 | 77 | 77 | 180.5 | 200 | 176.1 |
| | | 50%, max | 121 | 121 | 118 | 116 | 113 | 110 | | | |
| | | 90%, max | 190 | 190 | 190 | 185 | 185 | 185 | 302.5 | 316.5 | 360.6 |
| | | End Point, max | 225 | 225 | 225 | 225 | 225 | 225 | 421 | 429.5 | 448.4 |
| D86 | | Distillation Residue, vol %, max | 2 | 2 | 2 | 2 | 2 | 2 | — | — | — |
| D2622 | | Sulphur max mass % | 0.008 | 0.008 | 0.008 | 0.008 | 0.008 | 0.008 | 0.259 | 0.051 | 0.262 |

Those skilled in the art will appreciate that the invention described herein is susceptible to variations and modifications other than those specifically described. It is understood that the invention includes all such variations and modifications which fall within the spirit and scope of the present invention.

1-34. (canceled)

35. A process for producing a hydrocarbon fuel from a plastic material feedstock, comprising the steps of:
feeding a quantity of a feedstock of a plastic material to a pyrolysis reactor vessel;
heating the feedstock of plastic material in the pyrolysis reactor vessel at a pyrolysis temperature to form pyrolysis gases, wherein the pyrolysis reactor vessel is substantially oxygen free and at about atmospheric pressure;
condensing at least a portion of the pyrolysis gases in a condenser such that the condensed pyrolysis gases are returned to the pyrolysis reactor vessel;
optionally repeating the heating and condensing steps to undergo further pyrolysis; and
collecting at least a first product stream comprising a hydrocarbon fluid formed from pyrolysis to provide a hydrocarbon fuel; and
wherein the process does not comprise a catalyst.

36. The process according to claim 35, wherein the pyrolysis temperature is between about 200 to about 600° C.

37. The process according to claim 35, wherein the pressure of the pyrolysis reactor vessel is between about 80 to about 120 kPa.

38. The process according to claim 35, wherein the oxygen content of the pyrolysis reactor vessel is less than about 20%.

39. The process according to claim 35, wherein the yield of the first product stream is between about 50 to about 85 w/w %.

40. The process according to claim 35, wherein the first product stream is a liquid.

41. The process according to claim 35, wherein the first product stream meets at least two specifications of ASTM standards selected from the group consisting of ASTM D9752, ASTM D3699, ASTM D4814 and combinations thereof.

42. The process according to claim 35, wherein the first product stream is substantially a diesel fuel, petrol or kerosene.

43. The process according to claim 35, wherein the first product stream further comprises a refinement step.

44. The process according to claim 35, wherein the process comprises repeating the heating and condensing steps of pyrolysis gases at least once.

45. The process according to claim 35, wherein the process further comprises a second product stream of hydrocarbon fuel.

46. The process according to claim 35, wherein the process further comprises a third product stream.

47. The process according to claim 46, wherein the third product stream is a solid.

48. The process according to claim 45, wherein the process further comprises feeding the second product stream and/or third product stream to a burner system.

49. The process according to claim 35, wherein the feedstock of a plastic material is a comminuted plastic material.

50. An apparatus for use in the production of hydrocarbon fuel from a plastic material feedstock, the apparatus comprising:
a pyrolysis reactor vessel;
a feed inlet for feeding a plastic material feedstock into the pyrolysis reactor vessel;
a heating element for heating the pyrolysis reactor vessel configured such that a plastic material feedstock in the pyrolysis reactor vessel is heated at a pyrolysis temperature to form pyrolysis gases;
an agitator disposed within the pyrolysis reactor vessel to agitate a reaction melt of the plastic material feedstock in the pyrolysis reactor vessel during operation;
a condenser integrated with the pyrolysis reactor vessel to condense at least a portion of the pyrolysis gases such that the condensed pyrolysis gases are returned to the pyrolysis reactor vessel; and
an outlet for collecting a first product stream comprising a hydrocarbon fluid formed from pyrolysis to provide a hydrocarbon fuel from the pyrolysis reactor vessel; wherein pyrolysis reactor vessel is substantially oxygen free and at about atmospheric pressure; and
wherein the pyrolysis reactor vessel does not comprise a catalyst.

51. The apparatus according to claim 50, wherein the feed inlet is a directional channel to reduce or prevent bypass of gasses in the pyrolysis reactor vessel and/or is substantially perpendicular to the direction of flow of a pyrolysis gas stream.

52. The apparatus according to claim 50, wherein the outlet is a side draw channel which is substantially perpendicular to the direction of flow of a pyrolysis gas stream.

53. The apparatus according to claim 52, wherein the outlet is a curved channel or further comprises a bend, optionally the curved channel or the outlet further comprising a bend is substantially directed towards a parallel axis of the direction of flow of a pyrolysis gas stream.

54. The apparatus according to claim 50, further comprising one or more of:
a pyrolysis oil condenser in fluid communication with the outlet of the pyrolysis reactor vessel;
a fractionator column in fluid communication with the at least one flash tank; and
a burner system.
